(19) United States
(12) Patent Application Publication
(10) Pub. No.: US 2010/0170204 A1
(43) Pub. Date: Jul. 8, 2010

(54) CONTAINER LIDS AND METHODS OF SEALING CONTAINERS

(75) Inventor: Dana W. Altheimer, Marshall, NC (US)

Correspondence Address: DINSMORE & SHOHL LLP, 1900 CHEMED CENTER, 255 EAST FIFTH STREET, CINCINNATI, OH, 45202, US

(73) Assignee: ANCHOR HOCKING, LLC, Lancaster, OH (US)

(21) Appl. No.: 12/496,740

(22) Filed: Jul. 2, 2009

Related U.S. Application Data
(60) Provisional application No. 61/077,915, filed on Jul. 3, 2008.

(51) Int. Cl. B67B 6/00; B65D 41/16; B65D 43/08; B65D 51/00

(52) U.S. Cl. 53/476; 220/780; 220/796; 220/377

(57) ABSTRACT

A container lid including a pleat for expanding and contracting a perimeter of a sealing section, the sealing section including a first sealing portion and a second sealing portion, wherein when the container lid is sealed onto a container, the first sealing portion contacts an interior surface of the container and the second sealing portion contacts a top surface of the container.

### CROSS REFERENCE TO RELATED APPLICATIONS

This application claims the priority of U.S. Provisional Patent Application No. 61/077,915 filed Jul. 3, 2008, which is incorporated by reference in this specification.

### BACKGROUND

Mass produced glass and porcelain containers inherently have a small degree of size and shape variance from the manufacturing process. Accordingly, to effectively seal these glass containers, there is a continuing need for lids that can adapt to these small variances in size and shape.

### SUMMARY

In one embodiment, a container lid may include a pleat for expanding and contracting a perimeter of a sealing section, the sealing section including a first sealing portion and a second sealing portion, wherein when the container lid is sealed onto a container, the first sealing portion contacts an interior surface of the container and the second sealing portion contacts a top surface of the container.

In another embodiment, a container system may include a container and a container lid, wherein the container lid includes a fold for stretching an outer boundary of a sealing section, the sealing section including a first sealing portion and a second sealing portion, wherein when the container lid is in a sealed position with the container, the first sealing portion contacts an interior surface of the container and the second sealing portion contacts a top surface of the container.

In yet another embodiment, a method of sealing a container includes providing a container lid including a pleat for expanding and contracting a perimeter of a sealing section, the sealing section including a first sealing portion, and a second sealing portion, wherein when the container lid is sealed onto a container, the first sealing portion contacts an interior surface of the container and the second sealing portion contacts a top surface of the container; sealing the perimeter of the sealing section of the container lid on an upper rim of a container; breaking the seal at a location along the perimeter of the sealing section; pressing down on a center section of the container lid to expel gas from within the container; and resealing the perimeter of the sealing section on the upper rim of the container.

### BRIEF DESCRIPTION OF THE DRAWINGS

While the specification concludes with claims particularly pointing out and distinctly claiming the invention, it is believed that the same will be better understood from the following description taken in conjunction with the accompanying drawings in which:

FIG. 1 is a perspective view of an embodiment of a container system;

FIG. 2 is a top view of the embodiment of the container system shown in FIG. 1;

FIG. 3 is a cut-away side view of the embodiment of the container system shown in FIG. 1;

FIG. 4 is a close-up side view of a location along the perimeter of the sealing section of the embodiment of the container system shown in FIG. 1, wherein the sealing section of the container lid is sealed on the upper rim of a container;

FIG. 5 is a close-up side view of a location along the perimeter of the sealing section of the embodiment of the container system shown in FIG. 1, wherein the sealing section of the container lid is not sealed on the upper rim of a container and the center section of the container lid is depressed; and

FIG. 6 is a close-up side view of the sealing section of another embodiment of a container system.

### DETAILED DESCRIPTION

Container systems may include container lids and containers. As will be discussed in relation to the figures, embodiments of container lids 100 may generally include a center section 200 and a perimeter-oriented sealing section 300. It should be understood, however, that particular embodiments of the container lids described herein may incorporate additional features, such as, for example, a skirt 340 extending from sealing section 300.

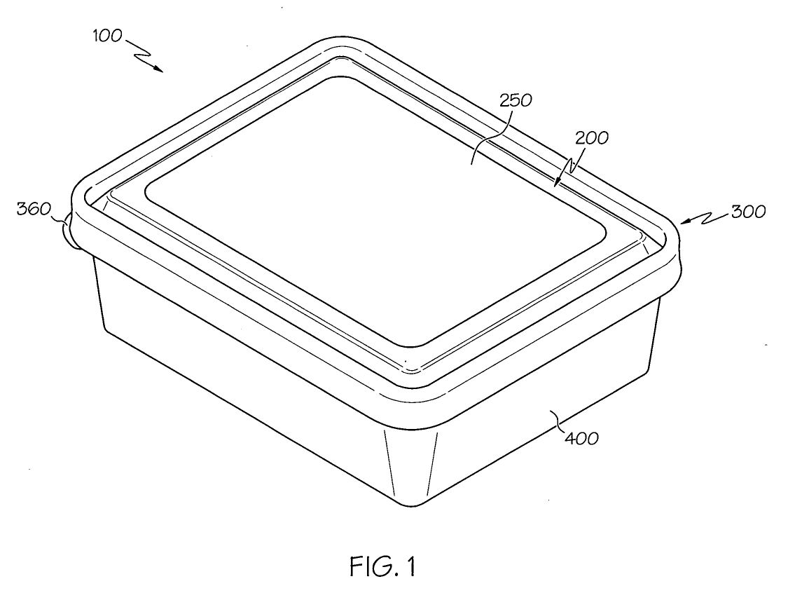

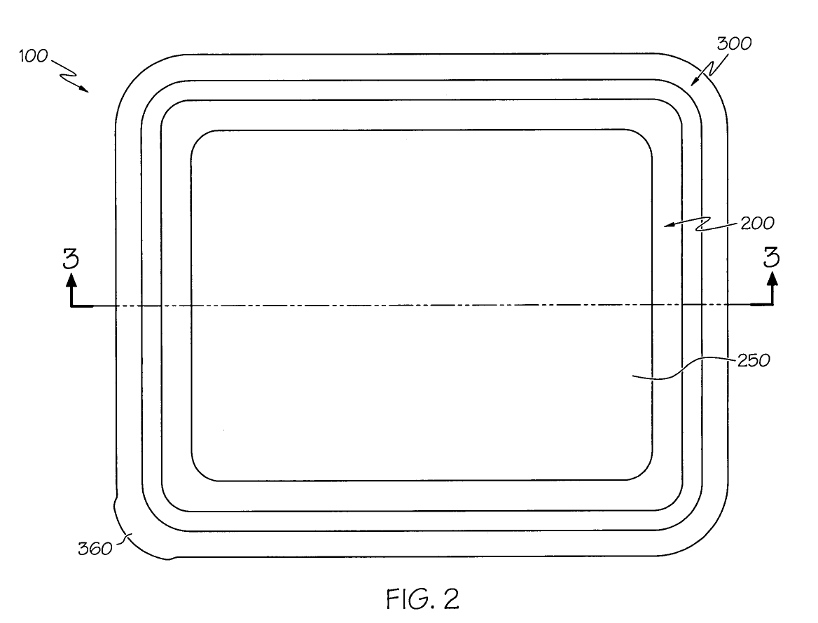

As depicted in the figures, center section 200 may comprise the portion of container lid 100 that covers a majority of the opening of a container 400. Sealing section 300 may comprise the portion of container lid 100 that seals the perimeter of the container lid to container 400. As depicted in FIGS. 1-3, embodiments of container lid 100 may include center section 200 that is relatively flat and rectangular in shape to match the rectangular shape and size of a particular container. However, embodiments of container lid 100 may include center section 200 that is of varying shape, size and/or profile to match the varying shapes and sizes of alternate containers. Moreover, embodiments of container lid 100 may include center section 200 that is concave, convex, or any other surface profile.

Additionally, center section 200 of container lid 100 may include, or fully comprise, a transparent section 250. Transparent section 250 will enable a user to view what is stored inside container 400. Transparent section 250 may be constructed of any transparent material known in the art, including, but not limited to, clarified polypropylene. As shown in FIGS. 1-3, the illustrated embodiment of container lid 100 includes center section 200 that almost fully comprises transparent section 250. However, embodiments of container lid 100 may include transparent section 250 that comprises a smaller percentage of center section 200, or need not include a transparent section at all. If transparent section 250 is included within an embodiment of container lid 100, the transparent section may be of any size, shape and/or profile.

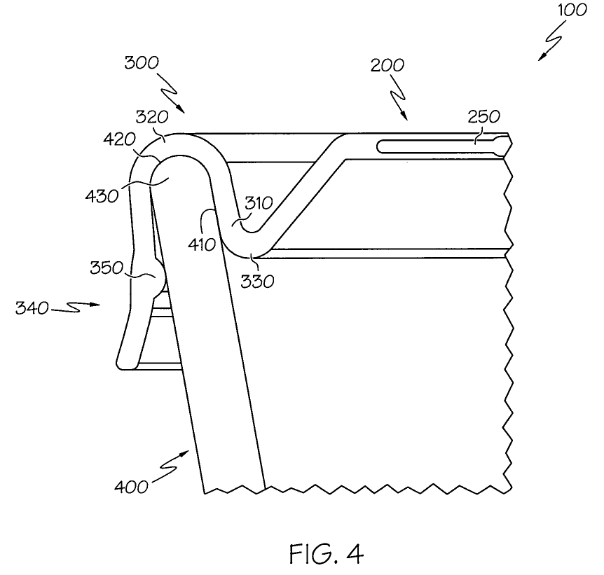

Sealing section 300 comprises the portion of container lid 100 that is utilized to seal the container lid to container 400. Sealing section 300 may be constructed of any material known in the art, including, but not limited to, varieties of thermoplastic elastomers. As depicted in FIGS. 4-6, sealing section 300 may comprise a “V” shaped (or “U” shaped) pleat, or fold, employed to contact and seal both an interior surface 410 and a top surface 420 of container 400. Accordingly, sealing section 300 may include a first sealing portion 310 that contacts (i.e., seals against) an interior surface 410 of container 400, and a second sealing portion 320 that contacts (i.e., seals against) a top surface 420 of container 400. First sealing portion 310 and second sealing portion 320 may be smooth, grooved, textured, or include any number and/or variety of ridges or protrusions. In some embodiments of container lid 100, additional or different sealing portions may be employed to contact additional or different surfaces of container 400, including, but not limited to, additional interior surfaces and any number of exterior surfaces. Accordingly, although sealing section 300 of the illustrated embodiments includes a “V” shaped fold, a pleat or fold of any shape, size and/or profile may be employed in the sealing section.

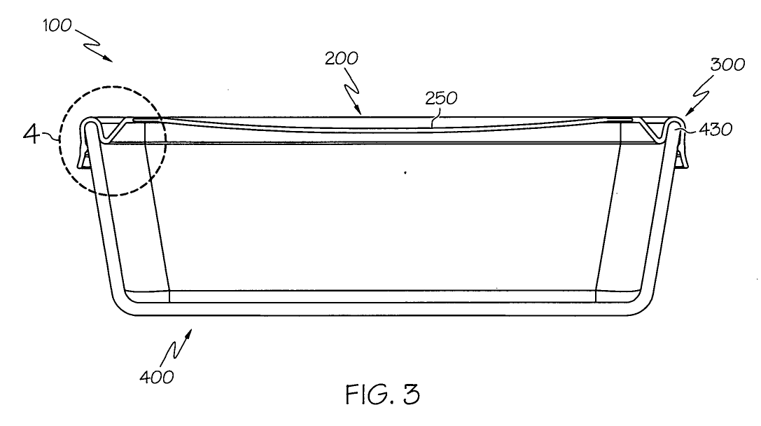

When container 400 is constructed of glass or porcelain, top surface 420 may be rounded, or convex in shape. FIGS. 3-5 illustrate container 400 with such a convex top surface 420. Accordingly, the shape of second sealing portion 320 of container lid 100 may be cupped to match or mimic the shape of top surface 420, thus providing increased contact area between the surfaces. This increased contact area between the surfaces may provide a better seal between container lid 100 and container 400, therefore assisting in the seal being watertight and/or airtight.

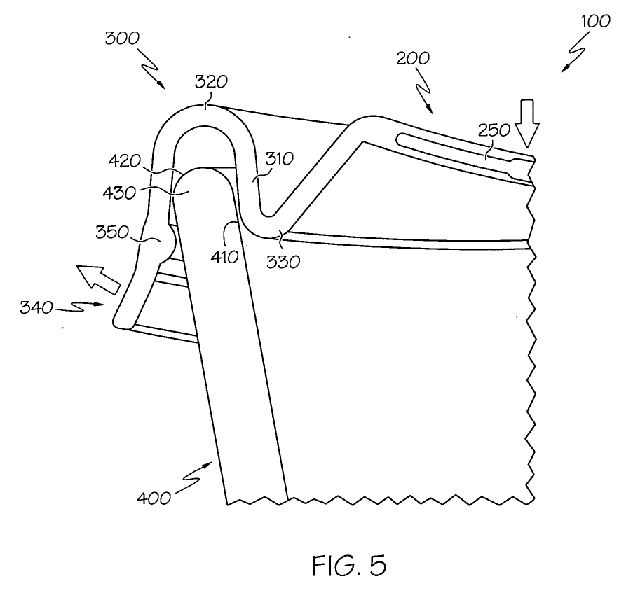

The “V” shaped pleat may be utilized to enable a uniformly manufactured container lid to effectively seal onto containers with slight variances in shape and size. As shown in FIG. 5, the bottom of the “V” shaped pleat, or hinge 330, may flex to allow the perimeter size and/or shape of sealing section 300 to expand and/or contract. Moreover, other locations of sealing section 300, such as the upper part of the “V” shaped pleat adjacent center section 200, may flex in concert with hinge 330 during expansion and/or contraction of the perimeter of sealing section 300. Accordingly, the deformable nature, or stretching capability, of the outer boundary of sealing section 300 allows container lid 100 to more effectively seal onto mass produced glass and porcelain containers that have an inherent variance in shape and size. In some embodiments, the ability of the perimeter of sealing section 300 to expand and/or contract assists in achieving a liquid tight and/or airtight seal between container lid 100 and container 400.

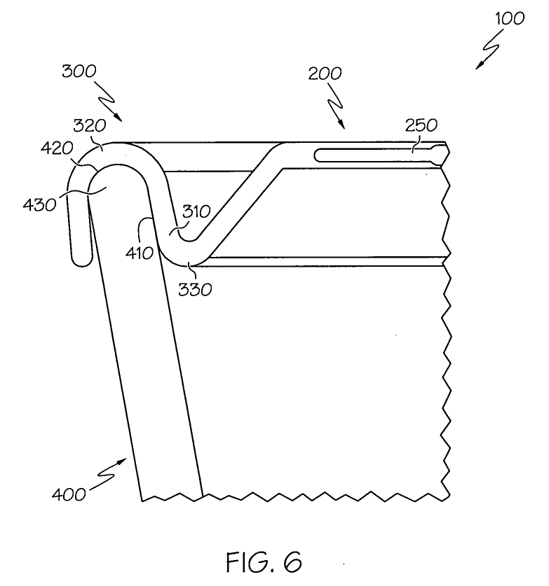

In some embodiments, container lid 100 may also include a skirt 340 extending from sealing section 300. Skirt 340 may assist in keeping container lid 100 sealed onto container 400. Some embodiments of container lid 100 that include skirt 340 may further contain rib 350. Rib 350 may provide support for skirt 340 in keeping the skirt from flaring away from container 400. However, embodiments of container lid 100 need not include rib 350, and further, need not include skirt 340. An embodiment of container lid 100 that lacks both skirt 340 and rib 350 is illustrated in FIG. 6.

The containers may be of any shape or size known in the art, and may be constructed of any material known in the art. In the illustrated embodiments, container 400 is a glass, rectangular dish. However, container 400 may be constructed of any material known in the art, including, but not limited to, glass, porcelain, ceramics, metals, wood, plastics and polymers. Moreover, container 400 may be formed into any shape known the art, including, but not limited to, square, rectangle, circle, oval, various polygons, and irregular shapes. In addition, the height, angles, and profiles of the walls of container 400 may also be of any construction known in the container art.

Container lid 100 may be sealed onto container 400 by various methods of engaging sealing section 300 onto the upper rim 430 of container 400. As previously detailed above, in some embodiments of container system, the seal between container lid 100 and container 400 may be airtight. In one particular sealing method that employs an airtight seal between container lid 100 and container 400, a vacuum can be created within the container. To create such a vacuum, a user first seals the entire perimeter of sealing section 300 onto upper rim 430 of container 400. This is depicted in FIGS. 4 and 6, wherein sealing section 300 is in a sealed position with container 400. The user may then utilize a tab 360 located on container lid 100 to break the seal at a particular location along the perimeter of sealing section 300. This is depicted in FIG. 5, wherein sealing section 300 is in a non-sealed position with container 400 at that particular location. Further, the illustrated embodiments of container lid 100 have a single tab 360 disposed in the corner of the container lid. However, any number of tabs may be disposed at any location(s) on container lid 100. Moreover, embodiments of container lid 100 need not include tab 360. For embodiments of container lid 100 that do not include tab 360, a user may just lift a portion (e.g., a corner) of the container lid from container 400 to break the seal in a particular location.

With the seal broken in a particular location along the perimeter of sealing section 300, the user may then press down on center section 200 of container lid 100 to expel an amount of gas (e.g., air) from inside container 400 though the location where the seal is broken. This force exerted on center section 200 is as also depicted in FIG. 5. Once an amount of gas is expelled from the container, the user may reseal container lid 100 onto container 400 at the location where the seal was previously broken (again, this sealed position is illustrated in FIGS. 4 and 6). Accordingly, the entire perimeter of sealing section 300 is in a sealed position with container 400. Because the seal between container lid 100 and container 400 is airtight, a vacuum is formed within the container. Such a vacuum created within container 400 (i.e., a vacuum seal between container lid 100 and container 400), may be desirable for the preservation of the contents (e.g., food) within the container.

The foregoing description of the various embodiments of container lids and methods of sealing containers have been presented for the purpose of illustration and description. It is not intended to be exhaustive or to limit the invention to the precise forms disclosed. Many alternatives, modifications, and variations will be apparent to those skilled in the art. Accordingly, the above description is intended to embrace all possible alternatives, modifications, combinations and variations that have been discussed herein, as well as all others that fall within the principles, spirit and broad scope of the invention as defined by the claims.

What is claimed:

1. A container lid comprising a pleat for expanding and contracting a perimeter of a sealing section, the sealing section comprising:
a first sealing portion; and
a second sealing portion;
wherein when the container lid is sealed onto a container, the first sealing portion contacts an interior surface of the container and the second sealing portion contacts a top surface of the container.

2. The container lid of claim 1, wherein the container is constructed of glass or porcelain, and further has a rounded top surface.

3. The container lid of claim 2, wherein the second sealing portion is cupped.

4. The container lid of claim 1, further comprising a transparent section.

5. The container lid of claim 1, further comprising a skirt extending from the sealing section.

6. The container lid of claim 5, further comprising a rib disposed along the skirt.

7. The container lid of claim 1, wherein the sealing section is constructed of a thermoplastic elastomer.

8. The container lid of claim 4, wherein the transparent section is constructed of polypropylene.

9. A container system comprising a container and a container lid;
wherein the container lid comprises a fold for stretching an outer boundary of a sealing section, the sealing section comprising:
a first sealing portion; and
a second sealing portion;
wherein when the container lid is in a sealed position with the container, the first sealing portion seals against an interior surface of the container and the second sealing portion seals against a top surface of the container.

10. The container system of claim 9, wherein the container is a glass container or a porcelain container.

11. The container system of claim 10, wherein the second sealing portion is cupped to match a rounded top surface of the glass container or the porcelain container.

12. The container system of claim 9, wherein the container lid further comprises a transparent section.

13. The container system of claim 9, wherein the container lid further comprising a skirt extending from the sealing section.

14. The container system of claim 13, wherein the container lid further comprising a rib disposed along the skirt.

15. A method of sealing a container comprising:
providing a container lid comprising a pleat for expanding and contracting a perimeter of a sealing section, the sealing section comprising a first sealing portion and a second sealing portion, wherein when the container lid is sealed onto a container, the first sealing portion contacts an interior surface of the container and the second sealing portion contacts a top surface of the container;
sealing the perimeter of the sealing section of the container lid on an upper rim of a container;
breaking the seal at a location along the perimeter of the sealing section;
pressing on a center section of the container lid to expel gas from within the container; and
resealing the perimeter of the sealing section on the upper rim of the container.

16. The method of claim 15, wherein a vacuum is formed within the container after resealing the perimeter of the sealing section on the upper rim of the container.

17. The method of claim 15, wherein a tab on the container lid is employed to break the seal at a location along the perimeter of the sealing section.
